(19) United States
(12) Patent Application Publication
(10) Pub. No.: US 2005/0195121 A1
(43) Pub. Date: Sep. 8, 2005

(54) Impedance matching apparatus in a mobile communication terminal

(75) Inventor: Seung Hun Paek, Seongnam-Si (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Curitel Communications, Inc.

(21) Appl. No.: 11/072,896

(22) Filed: Mar. 4, 2005

(30) Foreign Application Priority Data
Mar. 5, 2004 (KR) 10-2004-0015101

(51) Int. Cl. H01Q 1/24

(52) U.S. Cl. 343/860; 343/850

(57) ABSTRACT

Disclosed is an impedance matching apparatus in a mobile communication terminal. More particularly, the present invention relates to an impedance matching apparatus which may provide good RF characteristics regardless of opening and closing of a cover of a mobile communication terminal, by sensing the opening and closing of a cover of a mobile communication terminal and maintaining impedances of an antenna and a radio transmitting and receiving unit of the mobile communication terminal at an optimum matching state. The impedance matching apparatus can maintain an optimum impedance matching state between an antenna and a radio transmitting and receiving unit of a mobile communication terminal regardless of opening and closing of the cover, because it comprises two impedance matching circuits having different values of impedance. Meanwhile, the impedance matching apparatus may comprise two antennas having different values of impedance in addition to the two impedance matching circuits.

### CROSS-REFERENCE TO RELATED APPLICATION

The present application is claiming priority of Korean Patent Application No. 10-2004-0015101, filed on Mar. 5, 2004, the content of which is incorporated herein by reference.

### BACKGROUND OF THE INVENTION

1. Field of the Invention

The present invention relates to an impedance matching apparatus in a mobile communication terminal. More particularly, the present invention relates to an impedance matching apparatus which may provide good RF characteristics regardless of opening and closing of a cover of a mobile communication terminal, by sensing the opening and closing of a cover of a mobile communication terminal and maintaining impedances of an antenna and a radio transmitting and receiving unit of the mobile communication terminal at an optimum matching state.

2. Description of the Related Art

Antennas used to transmit and receive a RF (Radio Frequency) signal in a mobile communication terminal are classified into an external type and an internal type according to its mounted position, and into a helical type, a monopole type and a whip type according to its shape.

Regarding transmittance and reception performances of a mobile communication terminal, a user's form grasping the mobile communication terminal or a user's head position, etc. can exert a bad influence on a transmitting power (Tx power) emanated in a busy mode or standby mode, a receive sensitivity (Rx sensitivity) and an electromagnetic wave absorption rate (SAR; Specific Absorption Rate), etc. including a Standing Wave Ratio (SWR) and a radiation gain of an antenna. Accordingly, a selection of an antenna for minimizing such influence is an important factor dominating the transmittance and reception performances of a mobile communication terminal.

A whip antenna used in most mobile communication terminals has omni-directional characteristics. However, since the whip antenna adheres closely to a head during a telephone call, it is difficult to efficiently exclude the electromagnetic wave proceeding to the head.

Meanwhile, a flat-type antenna improved a SAR of the electromagnetic wave proceeding to the head. However, an efficiency and a gain of the antenna is instead lowered due to an inner structure for absorbing, reflecting or shielding the electromagnetic wave.

When a cover of a mobile communication terminal is opened or closed, for example, a flip or folder of a mobile communication terminal is opened or closed or a slide cover is up/down, impedance related to the antenna is changed. Thereby, a ground condition adjacent to the mobile communication terminal, i.e. RF characteristics is changed.

The change of the RF characteristics does not cause a large problem in an area where an intensity of a signal is strong. However, since it exerts a large influence on a reception performance of the RF signal in an area where an intensity of a signal is weak, it becomes often a cause that a good speech quality cannot be provided to a user.

Accordingly, a radio receive sensitivity is lowered and thus a speech quality is also inferior in an area where an intensity of a communication signal is weak.

### SUMMARY OF THE INVENTION

Accordingly, the present invention has been made to solve the abovementioned problems occurring in the prior art. The object of the present invention is to provide an impedance matching apparatus in a mobile communication terminal which may provide good RF characteristics regardless of opening and closing of a cover of a mobile communication terminal, by sensing opening and closing of a cover of a mobile communication terminal and maintaining impedances of an antenna and a radio transmitting and receiving unit of the mobile communication terminal at an optimum matching state.

Preferably, the switching unit may comprise: a first switching unit for connecting the antenna to the first impedance matching circuit when the cover of the mobile communication terminal is closed, and for connecting the antenna to the second impedance matching circuit when the cover of the mobile communication terminal is opened, according to the electrical signals outputted from the sensor unit; and a second switching unit for connecting the radio transmitting and receiving unit to the first impedance matching circuit when the cover of the mobile communication terminal is closed, and for connecting the radio transmitting and receiving unit to the second impedance matching circuit when the cover of the mobile communication terminal is opened, according to the electrical signals outputted from the sensor unit.

Preferably, the switching unit may comprise a switching diode.

Preferably, the sensor unit may comprise a flip switch.

Preferably, the sensor unit may comprise: a light transmitting element, provided at a specific position of the mobile communication terminal, for emitting light; and a light receiving element for sensing whether the light emitted from the light transmitting element reaches or not.

Preferably, the sensor unit may comprise: a magnet provided at a specific position of the cover of the mobile communication terminal; and a magnetic field sensing element, provided at a main body of the mobile communication terminal, for sensing a state of a magnetic field emanating from the magnet.

In order to accomplish the objects, there is provided an impedance matching apparatus in a mobile communication terminal comprising: a sensor unit for sensing opening and closing of a cover of the mobile communication terminal and outputting different levels of electrical signals according to the opening and closing; a switching unit for conducting switching operations according to the electrical signals outputted from the sensor unit; a first impedance matching circuit for being connected to an antenna and a radio transmitting and receiving unit depending on a switching operation of the switching unit when the cover of the mobile communication terminal is closed; and a second impedance matching circuit for being connected to the antenna and the radio transmitting and receiving unit depending on another switching operation of the switching unit when the cover of the mobile communication terminal is opened.

Preferably, the switching unit may comprise a switching diode.

Preferably, the sensor unit may comprise a flip switch.

Preferably, the sensor unit may comprise: a light transmitting element, provided at a specific position of the mobile communication terminal, for emitting light; and a light receiving element for sensing whether the light emitted from the light transmitting element reaches or not.

Preferably, the sensor unit may comprise: a magnet, provided at a specific position of the cover of the mobile communication terminal; and a magnetic field sensing element, provided at a main body of the mobile communication terminal, for sensing a state of a magnetic field emanating from the magnet.

In order to accomplish the objects, there is provided an impedance matching apparatus in a mobile communication terminal comprising: a sensor unit for sensing opening and closing of a cover of the mobile communication terminal and outputting different levels of electrical signals according to the opening and closing; a switching unit for conducting switching operations according to the electrical signals outputted from the sensor unit; an impedance matching circuit for conducting impedance matching between an antenna and a radio transmitting and receiving unit of the mobile communication terminal; a first antenna for being connected to the impedance matching circuit depending on a switching operation of the switching unit when the cover of the mobile communication terminal is closed; and a second antenna for being connected to the impedance matching circuit depending on another switching operation of the switching unit when the cover of the mobile communication terminal is opened.

### BRIEF DESCRIPTION OF THE DRAWINGS

The above and other objects, features and advantages of the present invention will be more apparent from the following detailed description taken in conjunction with the accompanying drawings, in which:

FIG. 1 is a circuit diagram of an impedance matching apparatus according to an embodiment of the present invention;

FIG. 2 is a circuit diagram of an impedance matching apparatus according to another embodiment of the present invention; and

FIG. 3 is a circuit diagram of a sensor unit for sensing opening and closing of a cover of a mobile communication terminal according to an embodiment of the present invention.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

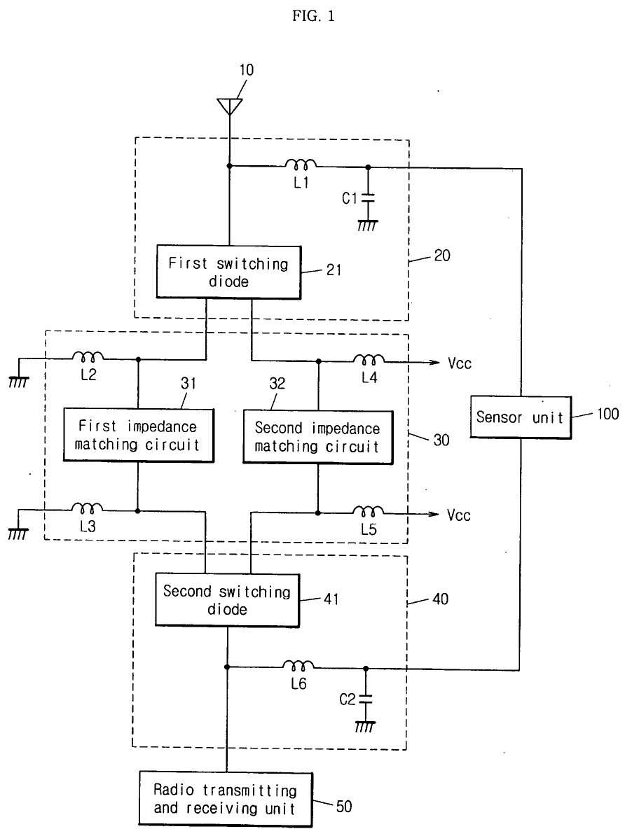

FIG. 1 shows a circuit diagram of an impedance matching apparatus according to an embodiment of the present invention. As shown, the impedance matching apparatus of the present invention comprises an impedance matching unit 30 including a first impedance matching circuit 31 and a second impedance matching circuit 32, a sensor unit 100, a first switching unit 20 and a second switching unit 40.

The first impedance matching circuit 31 and the second impedance matching circuit 32 have a respective impedance value different from each other. One of the circuits is selected depending on switching operations of the switching units 20, 40 and thus performs an impedance matching between an antenna 10 and a radio transmitting and receiving unit 50 of a mobile communication terminal.

The sensor unit 100 senses whether a cover of the mobile communication terminal is opened or closed and outputs different levels of electrical signals depending on the opened/closed state. For example, the sensor unit 100 can be configured to sense the opened state and output a high level of electrical signal via an output terminal 72 when the cover of the mobile communication terminal is opened, and configured to sense the closed state and output a low level of electrical signal via the output terminal 72 when the cover of the mobile communication terminal is closed.

The first switching unit 20 and the second switching unit 40 receive the electrical signal outputted from the sensor unit 100 and then are switched to one of the first impedance matching circuit 31 and the second impedance matching circuit 32. In other words, the switching units 20, 40 are switched to select an impedance matching circuit capable of maintaining impedances of the antenna 10 and the transmitting and receiving part 50 at an optimum matching state.

Each of the switching unit 20, 40 comprises a switching diode 21, 41 performing a switching function, an inductor L1, L6 filtering the signal sensing the opening and closing of the cover of the mobile communication terminal, and a capacitor C1, C2 respectively.

For instance, ‘HSMP_{—}389x’ and ‘HSMP_{—}489x’ manufactured by Agilent Corporation may be used as the switching diodes 21, 41.

Hereinafter, operations relating to an impedance matching of a mobile communication terminal will be described with reference to FIG. 1.

A RF signal received through the antenna 10 of the mobile communication terminal is transmitted to the radio transmitting and receiving unit 50 via the impedance matching unit 30. The radio transmitting and receiving unit 50 processes the received RF signal and thus conducts a voice communication and data communication, etc. The impedance matching circuits 31, 32 serve to maintain an impedance matching state between the antenna 10 and the radio transmitting and receiving unit 50.

Meanwhile, when a cover of a mobile communication terminal is opened or closed, a ground state of part adjacent to the mobile communication terminal is changed, thereby causing a change of an impedance of the antenna 10.

In this case, in order to prevent the impedance between the antenna 10 and the radio transmitting and receiving unit 50 from being a mismatching state, which is caused due to the change of the impedance of the antenna 10, the first switching unit 20 and the second switching unit 40 conduct switching operations.

In other words, when the cover of the mobile communication terminal is opened or closed, the sensor unit 100 senses the state change of the cover of the mobile communication terminal and outputs different levels of electrical signals according to the corresponding state change. For example, it may be set up such that when the cover of the mobile communication terminal is opened, a high level of an electrical signal is outputted, and when the cover of the mobile communication terminal is closed, a low level of an electrical signal is outputted.

The first switching unit 20 and the second switching unit 40 receive the electrical signal outputted from the sensor unit 100 and thus are switched to one of the first impedance matching circuit 31 and the second matching circuit 32.

For example, it is assumed that each of the first switching unit 20 and the second switching unit 40 is switched to the first impedance matching circuit 31 while the cover of the mobile communication terminal is closed. Under this state, when the cover of the mobile communication terminal is opened, the sensor unit senses the state change and outputs a high level of an electrical signal. The first switching unit 20 and the second switching unit 40 receive the high level of the electrical signal outputted from the sensor unit 100 and thus are switched to the second impedance matching circuit 32.

Meanwhile, a variety of sensor units such as a sensor unit using light and a sensor unit using a magnet, etc. may be applied in order to sense the opened and closed states of the cover of the mobile communication terminal.

The sensor unit using light comprises a light transmitting element and a light receiving element provided at predetermined positions, and senses the opened and closed states of the cover of the mobile communication terminal depending on whether the light emitted from the light transmitting element reaches the light receiving element or not.

The sensor unit using a magnetic field comprises a magnet provided at a specific position of the cover of the mobile communication terminal and a magnetic field sensing element provided at a main body of the mobile communication terminal so as to sense a state of a magnetic field emanating from the magnet.

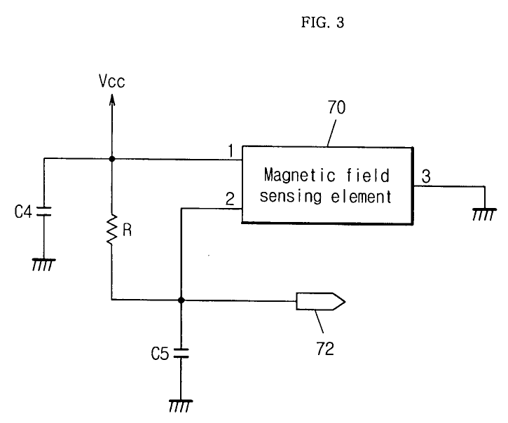

FIG. 3 illustrates a circuit diagram of the sensor unit using the magnetic field as described above. As shown in FIG. 3, the sensor unit using the magnetic field comprises a magnetic field sensing element 70, two capacitors C4, C5 and a resistance R. Operations of the sensor unit are as follows.

When the cover of the mobile communication terminal is opened or closed, a magnetic field state between a magnet (not shown) provided at the cover of the mobile communication terminal and the magnetic field sensing element 70 provided at a main body of the mobile communication terminal is changed. The magnetic field sensing element 70 senses the change of the magnetic field state and outputs different levels of electrical signals according to the change of the magnetic field state. The electrical signal is outputted via the output terminal 72 and applied to the switching unit.

In addition, a flip switch may be used to sense the opened and closed states of the cover of the mobile communication terminal.

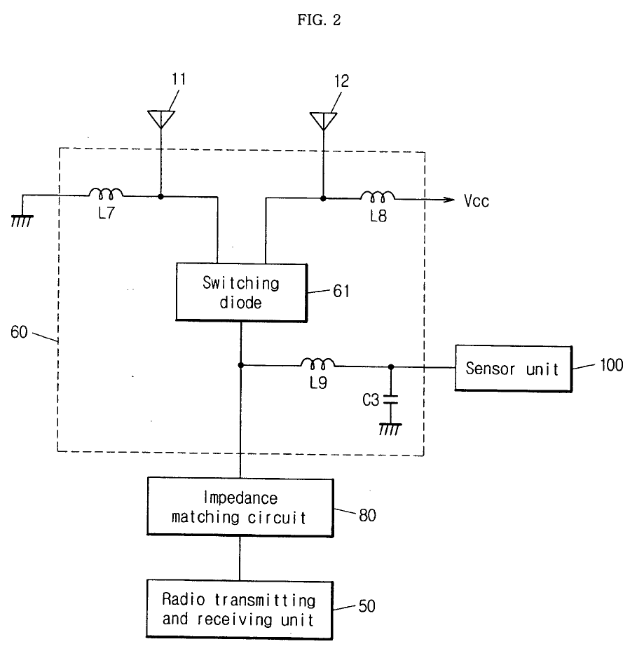

FIG. 2 illustrates a circuit diagram of an impedance matching apparatus according to another embodiment of the present invention.

The impedance matching apparatus shown in FIG. 2 comprises a sensor unit 100 for sensing opened and closed states of the cover of the mobile communication terminal and outputting different levels of electrical signals according to the opened and closed states of the cover; a switching unit 60 for conducting switching operations according to the electrical signals; an impedance matching circuit 80 for conducting an impedance matching between an antenna and a radio transmitting and receiving unit of the mobile communication terminal; a first antenna 11 for being connected to the impedance matching circuit depending on switching operations of the switching unit when the cover of the mobile communication terminal is closed; and a second antenna 12 for being connected to the impedance matching circuit depending on switching operations of the switching unit when the cover of the mobile communication terminal is opened.

That is, contrary to the matching apparatus of FIG. 1 comprising one antenna and two impedance matching circuits, the matching apparatus shown in FIG. 2 comprises two antennas and one impedance matching circuit.

The sensor unit 100 performs the same function as the sensor unit of FIG. 1. That is, it outputs different levels of electrical signals according to the opening and closing of the cover of the mobile communication terminal. For example, the sensor unit may be configured to output a high level of an electrical signal when the cover of the mobile communication terminal is opened, and configured to output a low level of an electrical signal when the cover of the mobile communication terminal is closed.

Similarly to the matching apparatus shown in FIG. 1, various sensor units such as a sensor unit using light and a sensor unit using a magnet, etc. can be applied to the matching apparatus shown in FIG. 2.

The switching unit 60 receives an electrical signal outputted from the sensor unit 100 and thus is switched to one of the first and second antennas 11, 12. While the matching apparatus shown in FIG. 1 uses two switching units 20, 40, this embodiment uses only one switching unit 60. The switching unit 60 may comprise an inductor L9, a capacitor C3 and a switching diode 61, similarly to the embodiment shown in FIG. 1.

The impedance matching circuit 80 performs an impedance matching function between one of the first and second antennas 11, 12 and the radio transmitting and receiving unit 50.

Each of the first and second antennas 11, 12 has an impedance value different from each other. The switching unit 60 is switched to one of the two antennas 11, 12 for an optimum impedance matching with the radio transmitting and receiving unit 50 according to the opened and closed states of the cover of the mobile communication terminal.

For example, it may be assumed that the switching unit is switched to the first antenna 11 while the cover of the mobile communication terminal is closed. When the cover of the mobile communication terminal is opened, the sensor unit 100 senses the change of the state and thus outputs a high level of an electrical signal. The switching unit 60 receives the high level of the electrical signal outputted from the sensor unit 100 and thus is switched to the second antenna 12.

Meanwhile, as an alternative embodiment of the present invention, a matching apparatus comprising all of the two impedance matching circuits having different values of impedances in FIG. 1 and the two antennas having different values of impedances in FIG. 2 may be provided.

To be more specific, the matching apparatus may comprise: a sensor unit for sensing opening and closing of a cover of the mobile communication terminal and outputting different levels of electrical signals according to the opening and closing; a switching unit for conducting switching operations according to the electrical signals outputted from the sensor unit; a first impedance matching circuit for being connected to an antenna and a radio transmitting and receiving unit depending on a switching operation of the switching unit when the cover of the mobile communication terminal is closed; and a second impedance matching circuit for being connected to the antenna and the radio transmitting and receiving unit depending on another switching operation of the switching unit when the cover of the mobile communication terminal is opened, and wherein the antenna comprises: a first antenna for being connected to the first impedance matching circuit depending on switching operations of the switching unit when the cover of the mobile communication terminal is closed; and a second antenna for being connected to the second impedance matching circuit depending on switching operations of the switching unit when the cover of the mobile communication terminal is opened.

In this case, regarding the number of the switching unit, two switching units for switching the two impedance matching circuits and one switching unit for conducting switching operations against the two antennas may be provided.

As describe above, the matching apparatus comprising two impedance matching circuits and two antennas can provide an optimum matching state by combining and switching the two impedance matching circuits and the two antennas whenever the cover of the mobile communication terminal is opened or closed.

For example, it is assumed that the switching units are switched to the first impedance matching circuit and the first antenna while the cover of the mobile communication terminal is closed. Under this state, when the cover of the mobile communication terminal is opened, the sensor unit senses the change of the state and outputs a corresponding electrical signal. Each of the switching units receives the electrical signal outputted from the sensor unit 100 and thus is switched to the second impedance matching circuit and the second antenna.

Meanwhile, the present invention can be applied to a case using a plurality of antennas in a mobile communication terminal supporting a dual band as well as a case using a plurality of antennas for improving a receive sensitivity in a mobile communication terminal.

In addition, the present invention can be applied to all mobile communication terminals including a flip type, a folder type and a slide type, etc., and particularly to a mobile communication terminal in which a RF signal characteristic of an antenna is changed due to an opening and closing of a flip or folder or up/down of a slide.

As described above, an impedance matching apparatus according to the present invention comprises two impedance matching circuits having different values of impedances and/or two antennas having different values of impedances, so that it can maintain an impedance between an antenna and a radio transmitting and receiving unit of a mobile communication terminal at an optimum matching state, regardless of opening and closing of a cover of the mobile communication terminal.

In other words, the impedance matching apparatus of the present invention can improve a radio receive sensitivity of a mobile communication terminal by compensating a change of a RF signal characteristic due to the change of the state of the cover of the mobile communication terminal.

While the present invention has been shown and described with reference to certain preferred embodiments thereof, it will be understood by those skilled in the art that various changes in form and details may be made therein without departing from the spirit and scope of the present invention as defined by the appended claims.

1. An impedance matching apparatus in a mobile communication terminal comprising:
a sensor unit for sensing opening and closing of a cover of the mobile communication terminal and outputting different levels of electrical signals according to the opening and closing;
a switching unit for conducting switching operations according to the electrical signals outputted from the sensor unit;
a first impedance matching circuit for being connected to an antenna and a radio transmitting and receiving unit depending on a switching operation of the switching unit when the cover of the mobile communication terminal is closed; and
a second impedance matching circuit for being connected to the antenna and the radio transmitting and receiving unit depending on another switching operation of the switching unit when the cover of the mobile communication terminal is opened.

2. The apparatus according to claim 1, wherein the switching unit comprises:
a first switching unit for connecting the antenna to the first impedance matching circuit when the cover of the mobile communication terminal is closed, and for connecting the antenna to the second impedance matching circuit when the cover of the mobile communication terminal is opened, according to the electrical signals outputted from the sensor unit; and
a second switching unit for connecting the radio transmitting and receiving unit to the first impedance matching circuit when the cover of the mobile communication terminal is closed, and for connecting the radio transmitting and receiving unit to the second impedance matching circuit when the cover of the mobile communication terminal is opened, according to the electrical signals outputted from the sensor unit.

3. The apparatus according to claim 1, wherein the switching unit comprises a switching diode.

4. The apparatus according to claim 1, wherein the sensor unit comprises a flip switch.

5. The apparatus according to claim 1, wherein the sensor unit comprises:
a light transmitting element, provided at a specific position of the mobile communication terminal, for emitting light; and
a light receiving element for sensing whether the light emitted from the light transmitting element reaches or not.

6. The apparatus according to claim 1, wherein the sensor unit comprises:
a magnet provided at a specific position of the cover of the mobile communication terminal; and
a magnetic field sensing element, provided at a main body of the mobile communication terminal, for sensing a state of a magnetic field emanating from the magnet.

7. An impedance matching apparatus in a mobile communication terminal comprising:
a sensor unit for sensing opening and closing of a cover of the mobile communication terminal and outputting different levels of electrical signals according to the opening and closing;
a switching unit for conducting switching operations according to the electrical signals outputted from the sensor unit;
an impedance matching circuit for performing impedance matching between an antenna and a radio transmitting and receiving unit of the mobile communication terminal;
a first antenna for being connected to the impedance matching circuit depending on a switching operation of the switching unit when the cover of the mobile communication terminal is closed; and
a second antenna for being connected to the impedance matching circuit depending on another switching operation of the switching unit when the cover of the mobile communication terminal is opened.

8. The apparatus according to claim 7, wherein the switching unit comprises a switching diode.

9. The apparatus according to claim 7, wherein the sensor unit comprises a flip switch.

10. The apparatus according to claim 7, wherein the sensor unit comprises:
a light transmitting element, provided at a specific position of the mobile communication terminal, for emitting light; and
a light receiving element for sensing whether the light emitted from the light transmitting element reaches or not.

11. The apparatus according to claim 7, wherein the sensor unit comprises:
a magnet, provided at a specific position of the cover of the mobile communication terminal; and
a magnetic field sensing element, provided at a main body of the mobile communication terminal, for sensing a state of a magnetic field emanating from the magnet.

12. An impedance matching apparatus in a mobile communication terminal comprising:
a sensor unit for sensing opening and closing of a cover of the mobile communication terminal and outputting different levels of electrical signals according to the opening and closing;
a switching unit for conducting switching operations according to the electrical signals outputted from the sensor unit;
a first impedance matching circuit for being connected to an antenna and a radio transmitting and receiving unit depending on a switching operation of the switching unit when the cover of the mobile communication terminal is closed; and
a second impedance matching circuit for being connected to the antenna and the radio transmitting and receiving unit depending on another switching operation of the switching unit when the cover of the mobile communication terminal is opened, and
wherein the antenna comprises:
a first antenna for being connected to the first impedance matching circuit depending on switching operations of the switching unit when the cover of the mobile communication terminal is closed; and
a second antenna for being connected to the second impedance matching circuit depending on switching operations of the switching unit when the cover of the mobile communication terminal is opened.
